(19) United States
(12) Patent Application Publication
(10) Pub. No.: US 2011/0272612 A1
(43) Pub. Date: Nov. 10, 2011

(54) VARIABLE VALVE LIFT APPARATUS

(75) Inventors: Byong-Young Choi, Incheon (KR); Young-Hong Kwak, Suwon-city (KR); Ki-Young Kwon, Seoul (KR); Sang-Won Kim, Seoul (KR); Jin-Kook Kong, Suwon-city (KR); Soo-Hyung Woo, Yongin-city (KR)

(73) Assignee: Hyundai Motor Company, Seoul (KR)

(21) Appl. No.: 12/941,700

(22) Filed: Nov. 8, 2010

(30) Foreign Application Priority Data
May 6, 2010 (KR) 10-2010-0042403

(51) Int. Cl. F16K 31/52

(52) U.S. Cl. 251/251

(57) ABSTRACT

A variable valve lift apparatus may include an opening/closing portion, a low lift cam which selectively contacts the opening/closing portion, a high lift cam which may be disposed parallel to the low lift cam, a control portion, a pad hinge connected to the control portion, and a pad, an end of which may be pivotally coupled to the pad hinge, the pad slidably contacting the high lift cam and the opening/closing portion, wherein, the control portion selectively changes position of the pad hinge.

### CROSS-REFERENCE TO RELATED APPLICATION

The present application claims priority to Korean Patent Application No. 10-2010-0042403 filed in the Korean Intellectual Property Office on May 6, 2010, the entire contents of which is incorporated herein for all purposes by this reference.

### BACKGROUND OF THE INVENTION

1. Field of the Invention

The present invention relates to a variable valve lift apparatus. More particularly, the present invention relates to a variable valve lift apparatus which may change valve lift according to engine operation condition.

2. Description of Related Art

An internal combustion engine generates power by burning fuel in a combustion chamber in air media drawn into the chamber. Intake valves are operated by a camshaft in order to intake the air, and the air is drawn into the combustion chamber while the intake valves are open. In addition, exhaust valves are operated by the camshaft, and a combustion gas is exhausted from the combustion chamber while the exhaust valves are open.

An optimal operation of the intake valves and the exhaust valves depends on a rotation speed of the engine. That is, an optimal lift or optimal opening/closing timing of the valves depends on the rotation speed of the engine. In order to achieve such an optimal valve operation depending on the rotation speed of the engine, various researches has been undertaken. For example, research has been undertaken for a variable tappet that enables different lifts depending on an engine speed.

The variable valve lift apparatus is required to minimize power loss during opening/closing of valves using torque of a camshaft.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a variable valve lift apparatus having advantages of improved fuel efficiency, minimized mechanical friction, simplified scheme and improved durability.

In an aspect of the present invention, the variable valve lift apparatus may include an opening/closing portion, a low lift cam which selectively contacts the opening/closing portion, a high lift cam which may be disposed parallel to the low lift cam, a control portion, a pad hinge connected to the control portion, and a pad, an end of which may be pivotally coupled to the pad hinge, the pad slidably contacting the high lift cam and the opening/closing portion, wherein, the control portion selectively changes position of the pad hinge.

The opening/closing portion may include a tappet body slidably contacting the pad, and a valve connected to the tappet body.

The pad may include a first contact portion which may be convexly formed and slidably contacts the high lift cam.

The pad may include a second contact portion which may be convexly formed and slidably contacts the tappet body, wherein the tappet body may include a guide portion which guides the second contact portion therein.

The control portion may include a cylinder, a piston slidably disposed within the cylinder and connected to the pad hinge, a connecting portion which selectively connects the cylinder and the piston, and a lost motion spring elastically supporting the cylinder.

The connecting portion may include a hydraulic pressure chamber formed in the piston, an assistance pin disposed within the hydraulic pressure chamber, wherein the assistance pin selectively receive hydraulic pressure, a latching pin disposed within the piston and selectively connected to the cylinder by the assistance pin, wherein the assistance pin abuts the latching pin in the hydraulic pressure chamber, and a connecting portion spring elastically biasing the latching pin.

The opening/closing portion may include a roller contacting the pad, a swing arm provided with the roller, and a valve connected to an end of the swing arm.

The control portion may include a cylinder, a piston slidably disposed within the cylinder and connected to the pad hinge, wherein an end of the pad may be pivotally connected to the pad hinge, a connecting portion which selectively connects the cylinder and the piston, and a lost motion spring elastically supporting the cylinder.

The connecting portion may include a hydraulic pressure chamber formed in the piston, an assistance pin disposed within the hydraulic pressure chamber, wherein the assistance pin selectively receive hydraulic pressure, a latching pin disposed within the piston and selectively connected to the cylinder by the assistance pin, wherein the assistance pin abuts the latching pin in the hydraulic pressure chamber, and a connecting portion spring elastically biasing the latching pin.

As described above, in the variable valve lift apparatus according to the exemplary embodiments of the invention, operational ranges of the cam for enhancement of fuel efficiency may be enlarged, and scheme for controlling of valve lift is separated so that weight of moving members may be reduced.

Also, mechanical friction may be reduced, and scheme may be simplified, so that durability may be increased.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view of a variable valve lift apparatus according to various exemplary embodiments of the present invention.

FIG. 2 is a front view of the variable valve lift apparatus according to various exemplary embodiments of the present invention.

FIG. 3 is a drawing showing high lift mode of the variable valve lift apparatus according to various exemplary embodiments of the present invention.

FIG. 4 is a drawing showing low lift mode of the variable valve lift apparatus according to various exemplary embodiments of the present invention.

FIG. 5 is drawing showing a variable valve lift apparatus according to various exemplary embodiments of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Exemplary embodiments of the present invention will hereinafter be described in detail with reference to the accompanying drawings.

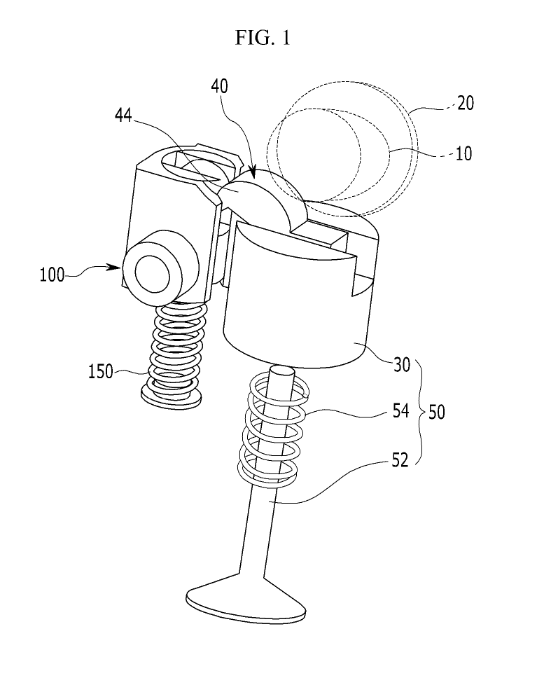

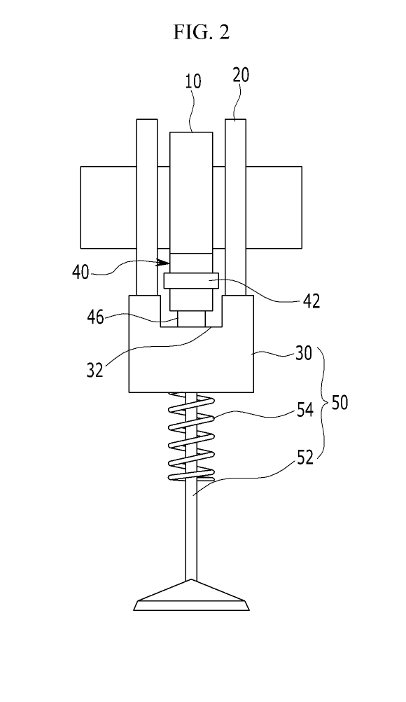

FIG. 1 and FIG. 2 are a perspective view and a front view of a variable valve lift apparatus according to the first exemplary embodiment of the present invention respectively.

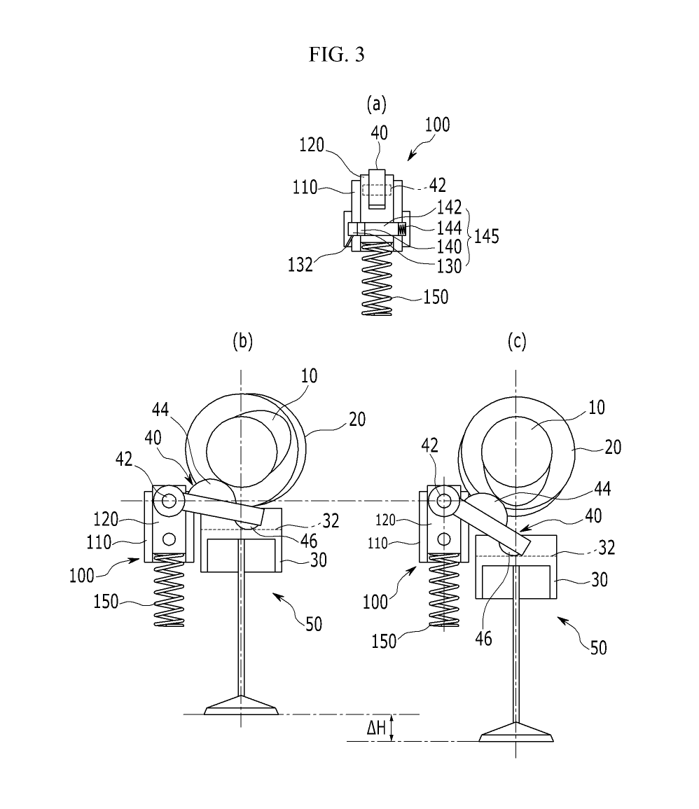

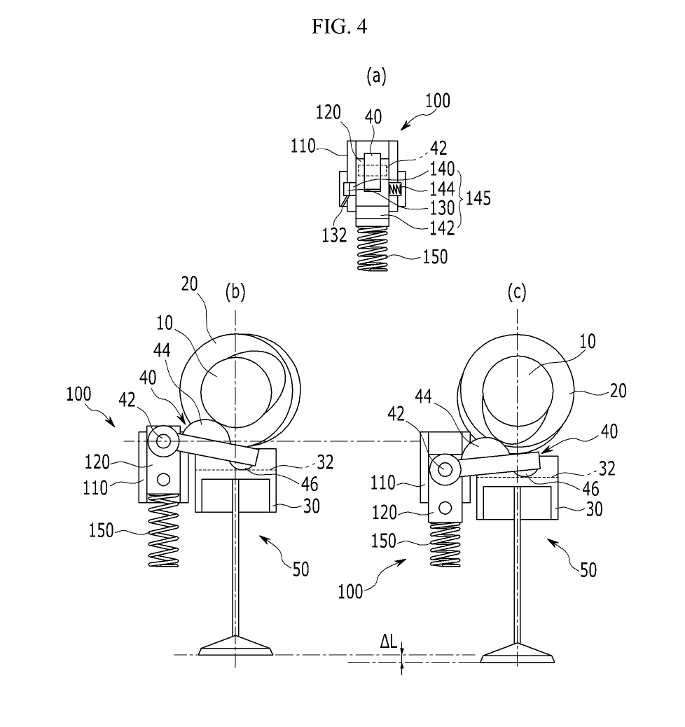

FIG. 3 and FIG. 4 is a drawing showing high lift mode and low lift mode of the variable valve lift apparatus according to the first exemplary embodiment of the present invention respectively.

Referring to FIG. 1 to FIG. 4, a variable valve lift apparatus according to the first exemplary embodiment of the present invention includes an opening/closing portion 50, a low lift cam 20 which selectively contacts the opening/closing portion 50, a high lift cam 10 which is disposed parallel to the low lift cam 20, a control portion 100, a pad hinge 42 connected to the control portion 100, and a pad 40 which pivots around the pad hinge 42 and contacts the high lift cam 10 and the opening/closing portion 50. Wherein the control portion 100 is disposed apart from the opening/closing portion 50 and selectively changes position of the pad hinge 42.

In the drawings, while the high lift cam 10 is disposed between the low lift cams 20, however, it is to be understood that the invention is not limited to the drawings, for example, the high lift cam 10 may be disposed parallel to the low lift cam 20.

The opening/closing portion 50 includes a tappet body 30 contacting the pad 40, a valve 52 connecting with the tappet body 30 and a valve spring 54.

The pad 40 includes a first contact portion 44 which is convexly formed and contacts the high lift cam 10, and a second contact portion 46 which is convexly formed and contacts the tappet body 30.

The first contact portion 44 may be formed as curved surface for reducing friction between the first contacting portion 44 and the high lift cam 10, and also the second contact portion 46 may be formed as curved surface for reducing friction between the second contacting portion 46 and the tappet body 30.

The tappet body 30 may include a guide portion 32 which guides the second contact portion 46, and also, the tappet body 30 may be a conventional tappet body, for example, an upper surface may be a curved surface or a flat surface.

The control portion 100 includes a cylinder 110, a piston 120 which is disposed within the cylinder 110 and connected to the pad hinge 42, a connecting portion 145 which selectively connects the cylinder 110 and the piston 120 and a lost motion spring 150 elastically supporting the cylinder 120.

The connecting portion 145 includes a hydraulic pressure chamber 130, an assistance pin 140 disposed within the hydraulic pressure chamber 130, a latching pin 142 disposed within the piston 120 and selectively connected to the cylinder 110 and a connecting portion spring 144 elastically supporting the latching pin 142.

The hydraulic pressure chamber 130 may be connected to an oil supply passage 132 to be supplied hydraulic pressure.

Hereinafter, referring to FIG. 3 and FIG. 4, operation of the variable valve lift apparatus according to the first exemplary embodiment of the present invention will be described.

As shown in FIG. 3, in high lift mode, hydraulic pressure is supplied from the oil supply passage 132 to the hydraulic pressure chamber 130.

The oil supply passage 132 receives hydraulic pressure from a hydraulic pump and hydraulic pressure is released through the oil supply passage 132, and supplying or releasing of the hydraulic pressure may be controlled by an ECU (engine control unit. not shown).

The ECU controls supplying or releasing of the hydraulic pressure according to operation condition of an engine, and the operation of the ECU is obvious to a person skilled in the art, so that detailed explanation will be omitted.

When the hydraulic pressure chamber 130 is supplied hydraulic pressure, the assistance pin 140 pushes the latching pin 142, and then the latching pin 142 connects the piston 120 and the cylinder 110.

And thus, the pad hinge 42 connected to the piston 120 is positioned at a predetermined position, and the opening/closing portion 50 is opened and closed by the rotation of the high lift cam 10 (ΔH).

In the low lift mode, as shown in FIG. 4, the hydraulic pressure in the hydraulic pressure chamber 130 is released through the oil supply passage 132.

When the hydraulic pressure in the hydraulic pressure chamber 130 is released, the assistance pin 140 and the latching pin 142 move by elastic force of the connecting portion spring 144 and the latching pin 142 is positioned within the piston 120 so that the piston 120 and the cylinder 110 are disengaged.

And thus, the pad hinge 42 connected to the piston 120, as shown in (b) and (c) of FIG. 4, moves up and down (lost motion) by the rotation of the high lift cam 10.

Accordingly, the low lift cam 20 contacts the tappet body 30, and the opening/closing portion is opened and closed by rotation of the low lift cam 20 (ΔL).

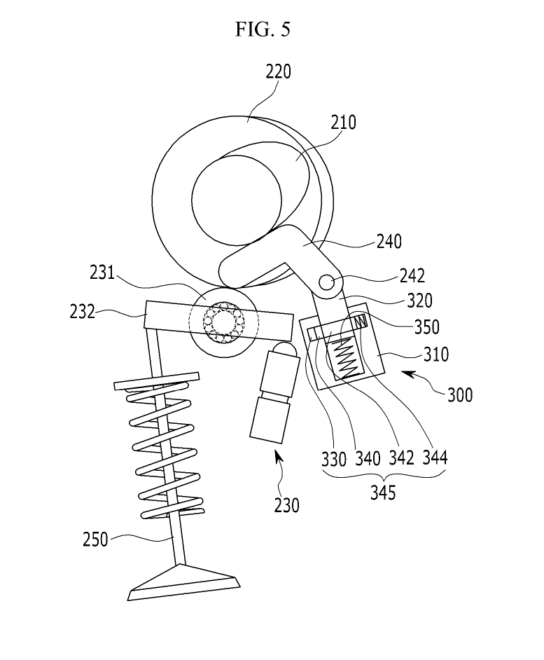

FIG. 5 is drawing showing a variable valve lift apparatus according to the second exemplary embodiment of the present invention.

Referring to FIG. 5, a variable valve lift apparatus according to the second exemplary embodiment of the present invention will be described.

A variable valve lift apparatus according to the second exemplary embodiment of the present invention includes a high lift cam 210, a low lift cam 220 which is disposed parallel to the high lift cam 210, an opening/closing portion 230, including a valve 250 and selectively contacting the low lift cam 220, a pad 240 which is disposed between the high lift cam 210 and the opening/closing portion 230, and contacts the high lift cam 210 and the opening/closing portion 230, a pad hinge 242 of which the pad 240 is connected thereto and pivots around the thereto and a control portion 300 which is disposed parallel to the opening/closing portion 230 and controls position of the pad hinge 242.

In the drawings, while the high lift cam 210 is disposed between the low lift cams 220, however, it is to be understood that the invention is not limited to the drawings, for example, the high lift cam 10 may be disposed parallel to the low lift cam 220.

The opening/closing portion 230 includes a roller 231 contacting the pad 240 and a swing arm 232 provided with the roller 231.

The control portion 300 includes a cylinder 310, a piston 320 which is disposed within the cylinder 310 and connected to the pad hinge 242, a connecting portion 345 which selectively connects the cylinder 310 and the piston 320 and a lost motion spring 350 elastically supporting the cylinder 310.

The connecting portion 345 includes a hydraulic pressure chamber 330, an assistance pin 340 disposed within the hydraulic pressure chamber 330, a latching pin 342 disposed within the piston 320 and selectively connected to the cylinder 310 and a connecting portion spring 344 elastically supporting the latching pin 342.

The second exemplary embodiment of the present invention is similar to the first exemplary embodiment of the present invention except for the tappet body so that detailed description will be omitted.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A variable valve lift apparatus comprising:
an opening/closing portion;
a low lift cam which selectively contacts the opening/closing portion;
a high lift cam which is disposed parallel to the low lift cam;
a control portion;
a pad hinge connected to the control portion; and
a pad, an end of which is pivotally coupled to the pad hinge, the pad slidably contacting the high lift cam and the opening/closing portion;
wherein, the control portion selectively changes position of the pad hinge.

2. The apparatus of claim 1, wherein the opening/closing portion comprises:
a tappet body slidably contacting the pad; and
a valve connected to the tappet body.

3. The apparatus of claim 2, wherein the pad comprises a first contact portion which is convexly formed and slidably contacts the high lift cam.

4. The apparatus of claim 2, wherein the pad comprises a second contact portion which is convexly formed and slidably contacts the tappet body.

5. The apparatus of claim 4, wherein the tappet body comprises a guide portion which guides the second contact portion therein.

6. The apparatus of claim 2, wherein the control portion comprises:
a cylinder;
a piston slidably disposed within the cylinder and connected to the pad hinge;
a connecting portion which selectively connects the cylinder and the piston; and
a lost motion spring elastically supporting the cylinder.

7. The apparatus of claim 6, wherein the connecting portion comprises:
a hydraulic pressure chamber formed in the piston;
an assistance pin disposed within the hydraulic pressure chamber, wherein the assistance pin selectively receive hydraulic pressure;
a latching pin disposed within the piston and selectively connected to the cylinder by the assistance pin, wherein the assistance pin abuts the latching pin in the hydraulic pressure chamber; and
a connecting portion spring elastically biasing the latching pin.

8. The apparatus of claim 1, wherein the opening/closing portion comprises:
a roller contacting the pad;
a swing arm provided with the roller; and
a valve connected to an end of the swing arm.

9. The apparatus of claim 8, wherein the control portion comprises:
a cylinder;
a piston slidably disposed within the cylinder and connected to the pad hinge, wherein an end of the pad is pivotally connected to the pad hinge;
a connecting portion which selectively connects the cylinder and the piston; and
a lost motion spring elastically supporting the cylinder.

10. The apparatus of claim 9, wherein the connecting portion comprises:
a hydraulic pressure chamber formed in the piston;
an assistance pin disposed within the hydraulic pressure chamber, wherein the assistance pin selectively receive hydraulic pressure;
a latching pin disposed within the piston and selectively connected to the cylinder by the assistance pin, wherein the assistance pin abuts the latching pin in the hydraulic pressure chamber; and
a connecting portion spring elastically biasing the latching pin.

11. A variable valve lift apparatus comprising:
a high lift cam;
a low lift cam which is disposed parallel to the high lift cam;
an opening/closing portion, including a valve and selectively contacting the low lift cam;
a pad which is disposed between the high lift cam and the opening/closing portion, and slidably contacts the high lift cam and the opening/closing portion;
a pad hinge of which the pad is connected thereto and pivots around the thereto; and
a control portion which is connected to the pad hinge and disposed parallel to the opening/closing portion and controls position of the pad hinge.

12. The apparatus of claim 11, wherein the opening/closing portion comprises a tappet body comprising a guide portion which guides the pad therein.

13. The apparatus of claim 12, wherein the control portion comprises:
a cylinder;
a piston slidably disposed within the cylinder and connected to the pad hinge;
a connecting portion which selectively connects the cylinder and the piston; and
a lost motion spring elastically supporting the cylinder.

14. The apparatus of claim 13, wherein the connecting portion comprises:
a hydraulic pressure chamber formed in the piston;
an assistance pin disposed within the hydraulic pressure chamber, wherein the assistance pin selectively receive hydraulic pressure;
a latching pin disposed within the piston and selectively connected to the cylinder by the assistance pin, wherein the assistance pin abuts the latching pin in the hydraulic pressure chamber; and
a connecting portion spring elastically biasing the latching pin.

15. The apparatus of claim 11, wherein the opening/closing portion comprises:
a roller contacting the pad; and
a swing arm provided with the roller.

16. The apparatus of claim 15, wherein the control portion comprises:
a cylinder;
a piston slidably disposed within the cylinder and connected to the pad hinge, wherein the pad is pivotally connected to the pad hinge;
a connecting portion which selectively connects the cylinder and the piston; and
a lost motion spring elastically supporting the cylinder.

17. The apparatus of claim 16, wherein the connecting portion comprises:
a hydraulic pressure chamber formed in the piston;
an assistance pin disposed within the hydraulic pressure chamber, wherein the assistance pin selectively receive hydraulic pressure;
a latching pin disposed within the piston and selectively connected to the cylinder by the assistance pin, wherein the assistance pin abuts the latching pin in the hydraulic pressure chamber; and
a connecting portion spring elastically biasing the latching pin.
